(19) United States
(12) Patent Application Publication
(10) Pub. No.: US 2014/0335220 A1
(43) Pub. Date: Nov. 13, 2014

(54) ANGLE PIN STRUCTURE AND INJECTION MOLD HAVING SAME

(71) Applicant: HON HAI PRECISION INDUSTRY CO., LTD., New Taipei (TW)

(72) Inventor: MIN-TSANG TSENG, New Taipei (TW)

(73) Assignee: HON HAI PRECISION INDUSTRY CO., LTD., New Taipei (TW)

(21) Appl. No.: 14/275,859

(22) Filed: May 12, 2014

(30) Foreign Application Priority Data
May 10, 2013 (TW) 102116630

(51) Int. Cl. B29C 45/17

(52) U.S. Cl. CPC B29C 45/1775
USPC 425/589

(57) ABSTRACT

Angle pin structure for ease of male and female mold disengagements includes an angle pin member, a sliding block, and an elastic unit between the angle pin member and the sliding block. The angle pin member includes a base, and the elastic unit is received in the base. When the sliding block moves close to the angle pin member on assembly of a male and female molding device, the elastic unit is elastically compressed between the sliding block and the angle pin member. When the molding device is to be broken open and the sliding block moved away from the angle pin member, the elastic force helps to push the sliding block away.

### FIELD

The present disclosure relates to injection molds, and particularly to an angle pin structure and an injection mold having the angle pin structure.

### BACKGROUND

An injection mold is used for injection molding products. After a product is formed, injection molding usually departs its male die and female die along a direction perpendicular to a separating surface. If the molded product has barbed structure, an undercutting or the like, the injection mold should depart its male die and female die along a direction which is not perpendicular or at a right angle to the separating surface.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic, isometric view of an angle pin structure, according to an exemplary embodiment of the present disclosure.

FIG. 2 is an exploded view of an angle pin member of the angle pin structure of FIG. 1.

FIG. 3 is similar to FIG. 2, but showing the angle pin member inverted.

FIG. 4 is a schematic, isometric view of an injection mold incorporating the angle pin structure of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

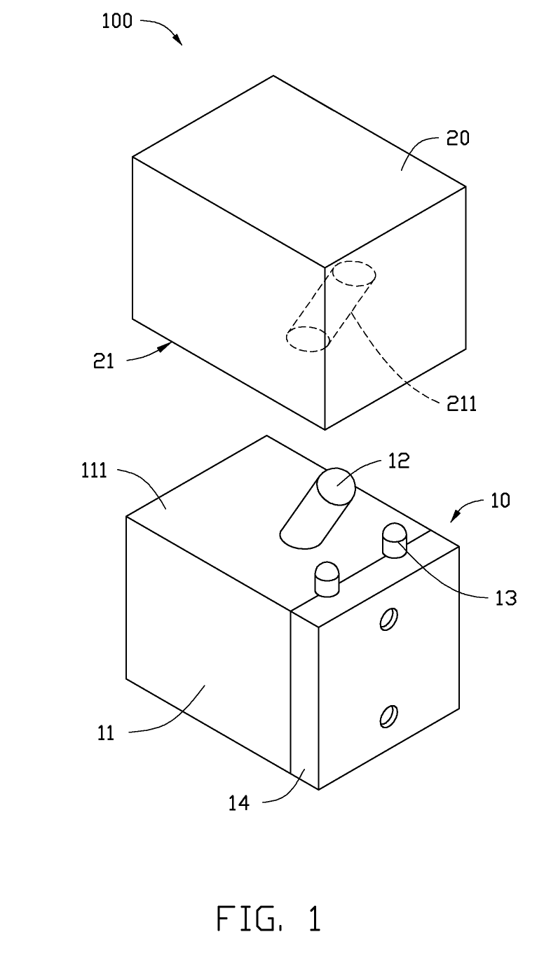

FIG. 1 illustrates an exemplary embodiment of an angle pin structure 100. The angle pin structure 100 includes an angle pin member 10 and a sliding block 20. The angle pin member 10 and the sliding block 20 slidably associate with each other.

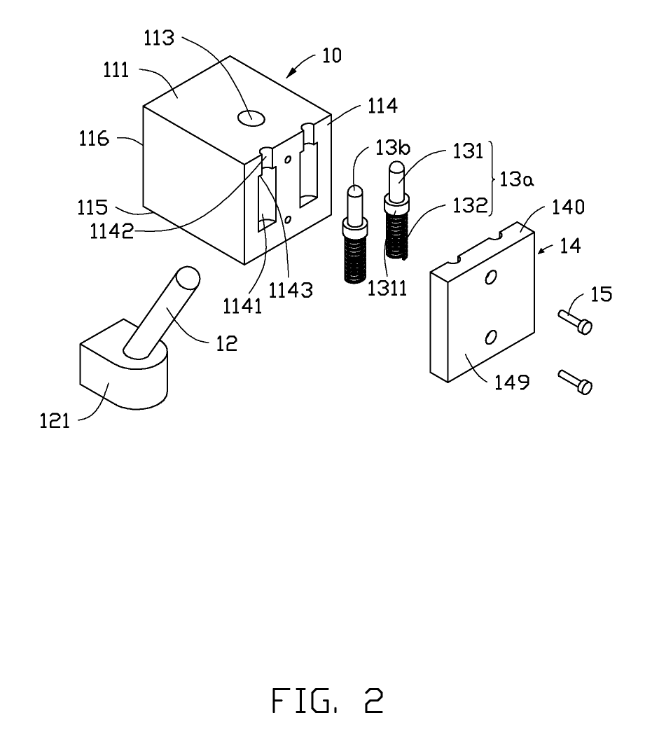

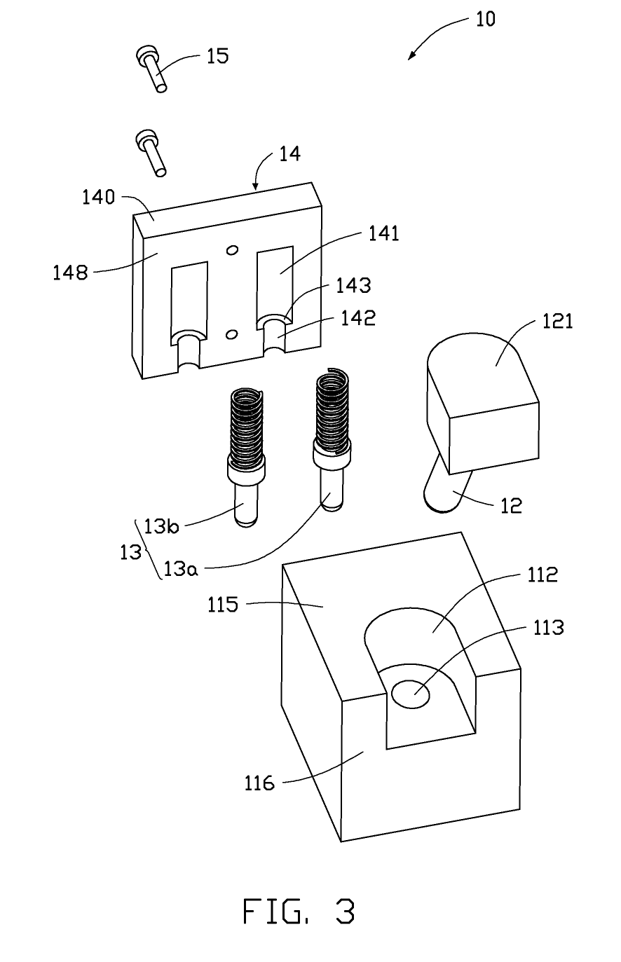

FIGS. 2-3 illustrate exploded views of the angle pin member 10. The angle pin member 10 includes a base 11, an angle pin 12, elastic unit 13, and a side-cover plate 14. The base 11 is substantially a cuboid. The base 11 includes a first fitting surface 111, a first side surface 114, a backside surface 115 and a second side surface 116. The first fitting surface 111 is opposite to the backside surface 115, and the first side surface 114 is opposite to the second side surface 116. The first side surface 114 and the second side surface 116 are perpendicularly connected to the first fitting surface 111 and the backside surface 115. The side-cover plate 14 is in contact with and covers the first side surface 114. The angle pin 12 protrudes from the first fitting surface 111 for a predetermined distance. A lengthwise direction of the angle pin 12 is inclined for a predetermined angle relative to the first fitting surface 111. The elastic unit 13 protrudes out of the first fitting surface 111 and can be elastically pressed into the first fitting surface 111.

The angle pin 12 is fixed with the base 11. In detail, the angle pin 12 and the base 11 can be integrally formed with each other, or the angle pin 12 can be detachably connected to the base 11. In this embodiment, the angle pin 12 and the base 11 are detachably connected to each other. The angle pin member 10 further includes an assembling block 121. The angle pin 12 is substantially a cylinder, one end of the angle pin 12 is fixedly connected to a surface of the assembling block 121, and the other end of the angle pin 12 protrudes from the assembling block 121 along an inclined direction relative to the surface of the assembling block 121. The base 11 defines a recess 112 in the backside surface 115. The recess 112 passes through the second side surface 116. The base 11 further defines an assembling hole 113 passing through from a bottom surface of the recess 112 to the first fitting surface 111. The assembling block 121 can fit in the recess 112. When the assembling block 121 is received and fixed in the recess 112, the angle pin 12 can pass through the assembling hole 113 and the other end of the angle pin 112 protrudes out of the base 11 from the first fitting surface 111.

The elastic unit 13 includes a first elastic member 13a and a second elastic member 13b. Each of the first elastic member 13a and the second elastic member 13b includes a shaft 131 and an elastic element 132. The shaft 131 includes a collar 1311 protruding from a peripheral surface of the shaft 131. In this embodiment, the collar 1311 is substantially ring-shaped, and the collar 1311 is formed on a substantial middle portion of the shaft 131. The elastic element 132 abuts against the collar 1311. In this embodiment, the elastic element 132 is a spring. The elastic element 132 sleeves on an end of the shaft 131 and presses against the collar 1311. The elastic unit 13 is elastically received in the base 11, and an end of the shaft 131 away from the elastic element 132 protrudes out of the base 11 from the first fitting surface 111. The end of the shaft 131 protruding from the base can be pressed into the first fitting surface 111. The elastic unit 13 can be elastically received in the base 11 in a variety of ways.

In this embodiment, the base 11 defines two first receiving grooves 1141 and two first guiding grooves 1142 in the first side surface 114. Each of the two first guiding grooves 1142 passes through the first fitting surface 111. Each first receiving groove 1141 communicates with a first guiding groove 1142. A size of each of the first guiding grooves 1142 is smaller than the size of each of the first receiving grooves 1141, thus a first step portion 1143 is formed between each first receiving groove 1141 and the corresponding first guiding groove 1142.

The side-cover plate 14 includes a top surface 140, a third side surface 148 and a fourth side surface 149. The third side surface 148 is opposite to the fourth side surface 149. The top surface 140 is connected between the third side surface 148 and the fourth side surface 149. The top surface 140 is coplanar with the first fitting surface 111 when the side-cover plate 14 covers the first side surface 114 and the third side surface 148 is in contact with the first side surface 114.

The side-cover plate 14 defines two second receiving grooves 141 and two second guiding grooves 142 in the third side surface 148 which substantially mirror the sizes and configurations of the two first receiving grooves 1141 and the two first guiding grooves 1142. Each of the two second guiding grooves 142 passes through the top surface 140. Each second receiving groove 114 communicates with a second guiding groove 142. A size of each of the second guiding grooves 142 is smaller than the size of each of the second receiving grooves 141, thus a second step portion 143 is formed between each second receiving groove 141 and a second guiding groove 142. One of the first receiving grooves 1141 and one of the second receiving grooves 141 cooperatively form a receiving hole, and one of the first guiding grooves 1142 and one of the second guiding grooves 142 cooperatively form a guiding hole when the side-cover plate 14 is fixed to the base 11. The other of the first receiving grooves 1141 and the other of the second receiving grooves 141 cooperatively form another receiving hole, and the other of the first guiding grooves 1142 and the other of the second guiding grooves 142 cooperatively form another guiding hole. Each first step portion 1143 and a second step portion 143 cooperatively form a ring-shaped step. In this embodiment, the side-cover plate 14 is fixed to the first side surface 114 by means of two bolts 15. The first elastic member 13a is received in one receiving hole and one guiding hole as described above, and the second elastic member 13b is received in the other receiving hole and the other guiding hole. The shaft 131 passes through a guiding hole and protrudes from the first fitting surface 111 and the top surface 140. In detail, the elastic element 132 and one end of the shaft 131 and the collar 1311 are received in the receiving hole. The elastic element 132 sleeves on the one end of the shaft 131. The elastic element 132 elastically presses against the collar 1311 and a bottom of the receiving hole. The collar 1311 is captive in the receiving hole by virtue of the ring-shaped step, and the other end of the shaft 131 passes through the guiding hole and protrudes from the first fitting surface 111 and the top surface 140.

Referring to FIG. 1, the sliding block 20 includes a second fitting surface 21. The second fitting surface 21 faces toward the first fitting surface 111. The sliding block 20 defines an inclined hole 211 in the second fitting surface 21. The central axis of the inclined hole 211 is inclined for the predetermined angle relative to the second fitting surface 21. The angle pin 12 can be inserted into the inclined hole 211 to bring the second fitting surface 21 into contact with the first fitting surface 111.

When the second fitting surface 21 moves close to the first fitting surface 111 along the lengthwise direction of the angle pin 12, the elastic unit 13 is gradually compressed by the second fitting surface 21. The shaft 131 is totally received in the receiving hole and the guiding hole when the second fitting surface 21 is in contact with the first fitting surface 111. In this way, elastic unit 13 acts as a shock absorber when the second fitting surface 21 moves close to the first fitting surface 111. When the second fitting surface 21 and the first fitting surface 111 need to be separated, an elastic force provided by the elastic unit 13 helps to push away the second fitting surface 21. In other embodiments, elastic unit can also be received or assembled in a sliding block.

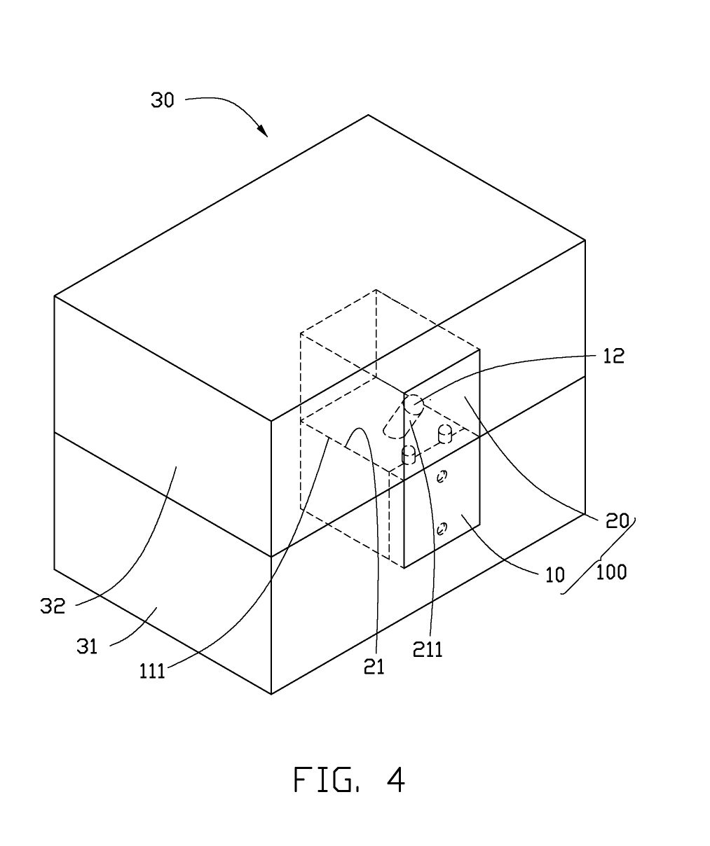

As shown in FIG. 4, the angle pin structure 100 can be used in an injection mold 30. In detail, the injection mold 30 includes a male die 31 and a female die 32. The angle pin member 10 is assembled in the male die 31, and the sliding block 20 is assembled in the female die 32. The first fitting surface 111 faces toward the second fitting surface 21, and both are parallel to a separating surface of the injection mold 30. In assembly, the angle pin 12 is inserted into the inclined hole 211 and the female die 32 can move close to the male die 31 along the lengthwise direction of the angle pin 12. In other embodiments, the angle pin member can be assembled in a female die, and the sliding block can be assembled in a male die.

The above-described angle pin structure uses the elastic unit which is received in the base to provide an elastic force between the sliding block and the angle pin member. When the sliding block moves close to the angle pin member, the elastic unit is compressed and acts as a shock absorber. When the sliding block moves away from the angle pin member, the elastic force helps to push the sliding block away.

Although numerous characteristics and advantages of the present embodiments have been set forth in the foregoing description, together with details of the structures and functions of the embodiment, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An angle pin structure, the angle pin structure comprising:
an angle pin member comprising a first fitting surface and an angle pin, the angle pin protruding from the first fitting surface and a lengthwise direction of the angle pin being inclined for a predetermined angle relative to the first fitting surface;
a sliding block comprising a second fitting surface, the sliding block defining an inclined hole in the second fitting surface corresponding to the angle pin, the central axis of the inclined hole being inclined for the predetermined angle relative to the second fitting surface, the angle pin being slidably inserted into the inclined hole; and
an elastic unit elastically positioned between the angle pin member and the sliding block, and when the first fitting surface being in contact with the second fitting surface, the elastic unit being elastically compressed between the angle pin member and the sliding block.

2. The angle pin structure of claim 1, wherein the angle pin member comprises a base, the first fitting surface is positioned on the base, the angle pin is fixed to the base and the elastic unit is elastically received in the base and protrudes from the first fitting surface.

3. The angle pin structure of claim 2, wherein the angle pin member further comprises an assembling block, the base further comprises a backside surface, the backside surface is opposite to the first fitting surface, the base defines a recess in the backside surface, the base also defines an assembling hole passing through from a bottom surface of the recess to the first fitting surface, one end of the angle pin is fixedly connected to the assembling block, the assembling block can be received and fixed in the recess, the angle pin can pass through the assembling hole and the other end of the angle pin can protrude out of the base from the first fitting surface.

4. The angle pin structure of claim 2, wherein the elastic unit comprises two elastic members, each of the two elastic members comprises a shaft and an elastic element, the elastic element presses against the shaft, the shaft protrudes out of the base from the first fitting surface, the elastic element is received in the base, the elastic element elastically presses against the shaft and the base.

5. The angle pin structure of claim 4, wherein the shaft defines a collar protruding from a peripheral surface of the shaft, the collar is formed on a substantial middle portion of the shaft, the elastic element elastically presses against the collar and the base.

6. The angle pin structure of claim 5, wherein the angle pin member further comprises a side-cover plate, the side-cover plate comprises a top surface, the base further comprises a first side surface, the first side surface is connected to the first fitting surface, the side-cover plate contacts and covers the first side surface, the top surface is coplanar with the first fitting surface, the base and the side-cover plate cooperatively receive the elastic unit, and the shaft protrudes from the first fitting surface and the top surface.

7. The angle pin structure of claim 6, wherein the base defines two first receiving grooves and two first guiding grooves in the first side surface, each of the two first guiding grooves passes through the first fitting surface, each first receiving groove communicates with a first guiding groove, a size of each of the first guiding grooves is smaller than the size of each of the first receiving grooves and a first step portion is defined between each first receiving groove and the corresponding first guiding groove.

8. The angle pin structure of claim 7, wherein the side-cover plate further comprises a third side surface, the side-cover plate defines two second receiving grooves and two second guiding grooves in the third side surface, each of the two second guiding grooves passes through the top surface, each second receiving groove communicates with a second guiding groove, a size of each of the second guiding grooves is smaller than the size of each of the second receiving grooves and a second step portion is defined between each second receiving groove and the corresponding second guiding groove, each first receiving groove and a second receiving groove cooperatively form a receiving hole, each first guiding groove and a second guiding groove cooperatively form a guiding hole, each first step portion and a second step portion cooperatively form a ring-shaped step, the elastic element and one end of the shaft and the collar are received in the receiving hole, the elastic element sleeves on one end of the shaft, the elastic element elastically presses against the collar and a bottom of the receiving hole, the collar is captive in the receiving hole by virtue of the ring-shaped step, and the other end of the shaft passes through the guiding hole and protrudes the first fitting surface and the top surface.

9. The angle pin structure of claim 4, wherein the elastic element is a spring.

10. An injection mold, the injection mold comprising an angle pin structure, the angle pin structure comprising:
an angle pin member comprising a first fitting surface and an angle pin, the angle pin protruding from the first fitting surface and a lengthwise direction of the angle pin being inclined for a predetermined angle relative to the first fitting surface;
a sliding block comprising a second fitting surface, the sliding block defining an inclined hole in the second fitting surface corresponding to the angle pin, the central axis of the inclined hole being inclined for the predetermined angle relative to the second fitting surface, the angle pin being slidably inserted into the inclined hole; and
an elastic unit elastically positioned between the angle pin member and the sliding block, and when the first fitting surface being in contact with the second fitting surface, the elastic unit being elastically compressed between the angle pin member and the sliding block.
